(19) United States
(12) Patent Application Publication
(10) Pub. No.: US 2026/0229988 A1
(43) Pub. Date: Aug. 6, 2026

(54) INITIAL STARTING APPARATUS AND METHOD FOR SOLID-STATE TRANSFORMER

(71) Applicant: LS ELECTRIC CO., LTD., Anyang-si, Gyeonggi-do (KR)

(72) Inventors: Jeong Woo LIM, Anyang-si, Gyeonggi-do (KR); Jae Ho LEE, Anyang-si, Gyeonggi-do (KR)

(21) Appl. No.: 19/146,620

(22) PCT Filed: Jan. 4, 2024
(86) PCT No.: PCT/KR2024/000168

§ 371 Date: Jul. 9, 2025

(30) Foreign Application Priority Data
Mar. 29, 2023 (KR) 10-2023-0040930

(51) Int. Cl. H02M 1/36; H02M 1/00

(52) U.S. Cl. CPC H02M 1/36; H02M 1/007

(57) ABSTRACT

The present disclosure relates to an initial starting apparatus and method for a solid-state transformer, the initial starting apparatus comprising: a plurality of power conversion unit modules connected in series with each other; and a synchronization controller that provides a synchronization signal of a set cycle to the plurality of power conversion unit modules so that the plurality of power conversion unit modules operate according to the synchronization signal, wherein each of the plurality of power conversion unit modules may be started by determining a detected synchronization signal as a start signal when not in operation.

### CROSS-REFERENCE TO RELATED APPLICATIONS

This application is a National Stage of International Application No. PCT/KR2024/000168, filed Jan. 4, 2024, which claims priority to and the benefit of Korean Patent Application No. 10-2023-0040930, filed Mar. 29, 2023, the disclosures of which are incorporated herein by reference in its entirety.

### FIELD

The present disclosure relates to an initial starting apparatus and method for a solid-state transformer, and more specifically to an initial starting apparatus and method for a solid-state transformer including a plurality of series-connected modules.

### BACKGROUND

Power transformers play a role in distinguishing between branches such as transmission, distribution and distribution in a system through voltage variation. However, existing power transformers directly vary the voltage of low-frequency AC, and thus, they have large components, large volume and mass, and input/output control is impossible.

In order to solve these problems of existing power transformers, a solid-state transformer (SST) was proposed. In other words, a solid-state transformer is a method in which the configuration of a power conversion device is changed to a more efficient way compared to existing power transformers. These solid-state transformers can be applied to various technologies such as renewable energy, DC distribution and electric vehicle charging through a DC link.

In particular, solid-state transformers can implement various functions such as AC/DC power conversion, power factor and harmonic control, in addition to voltage variation, and by adopting a high-frequency transformer, the volume and weight can be significantly reduced compared to existing power transformers. In addition, a unit SST cannot be input with high voltage due to the limitation of the semiconductor switch capacity, but a modular SST that connects unit SSTs in series can be input with high voltage.

Korean Patent Laid-Open Publication No. 10-2022-0149064 (published on Nov. 8, 2022) of the Applicant of the present disclosure describes that solid-state transformer modules can be connected in series or in parallel, or that series and parallel connections can be mixed.

When solid-state transformer unit modules are connected in parallel with each other, the system can be operated stably even if each module is not started at the same time, but when connected in series, the converted power must be converted sequentially to the next order, and thus, control of the starting time of each module is required.

However, if the serially connected unit SST module does not start or the starting is delayed due to various causes, the entire solid-state transformer system cannot be operated or unstable operation occurs.

This can be understood as the individual operation of each unit module in the serially connected state affects the performance of a neighboring unit module.

### SUMMARY

The problem that the present disclosure seeks to solve in consideration of the problems of the related art as described above is to provide an initial startup apparatus and method for a solid-state transformer that are capable of simultaneously starting a plurality of unit modules that are interconnected in series without using a separate additional device.

In order to solve the technical problem described above, the initial starting apparatus of a solid-state transformer according to an aspect of the present disclosure may include a plurality of power conversion unit modules connected in series with each other; and a synchronization controller configured to provide a synchronization signal of a set cycle to the plurality of power conversion unit modules such that the plurality of power conversion unit modules operate according to the synchronization signal, wherein each of the plurality of power conversion unit modules is started by determining a detected synchronization signal as a start signal when not in operation.

In an embodiment of the present disclosure, the power conversion unit module may include a driving part including a rectifier and a converter to convert power, and configured to charge a link capacitor between the rectifier and the converter during a startup.

In an embodiment of the present disclosure, the driving part may control a switch of the rectifier or the converter according to the synchronization signal.

In an embodiment of the present disclosure, the driving part may control the rectifier to charge the link capacitor.

In an embodiment of the present disclosure, the initial starting apparatus may further include a charging circuit configured to charge the link capacitor according to a control of the driving part.

In addition, the method for initially starting a solid-state transformer according to another aspect of the present disclosure that includes a plurality of power conversion unit modules connected in series with each other, and a synchronization controller configured to provide a synchronization signal of a set cycle to the plurality of power conversion unit modules such that the plurality of power conversion unit modules operate according to the synchronization signal, the method including determining whether a synchronization signal is input from the synchronous controller in each of the plurality of power conversion unit modules; checking whether the plurality of power conversion unit modules are currently operating if a synchronization signal is input, and determining as a synchronization signal if the plurality of power conversion unit modules are operating; and determining as a start command if the plurality of power conversion unit modules are not operating to start each of the power conversion unit modules.

In an embodiment of the present disclosure, each of the power conversion unit modules may include a link capacitor Connecting the rectifier and the converter, and a startup of the power conversion unit module may be to charge the link capacitor.

In an embodiment of the present disclosure, when the synchronization signal is input, if each of the power conversion unit modules is operating, power may be converted in synchronization with the synchronization signal.

The present disclosure has the effects of enabling the stable operation of a solid-state transformer by simultaneously operating a plurality of unit modules by transmitting a start signal loaded on the synchronization signal of each module in a solid-state transformer in which a plurality of unit modules are connected in series to convert high-voltage alternating current power into low-voltage alternating current or low-voltage direct current power.

### BRIEF DESCRIPTION OF THE DRAWINGS

FIG. 1 is a block diagram of an initial starting apparatus of a solid-state transformer according to a preferred embodiment of the present disclosure.

FIG. 2 is a block diagram of a unit module.

FIG. 3 is a waveform diagram of a synchronization signal used in the present disclosure.

FIG. 4 is a flowchart of a method for initially starting a solid-state transformer according to a preferred embodiment of the present disclosure.

### DETAILED DESCRIPTION

In order to fully understand the configurations and effects of the present disclosure, preferred embodiments of the present disclosure will be described with reference to the attached drawings. However, the present disclosure is not limited to the embodiments disclosed below, but can be implemented in various forms and can have various changes. However, the description of the embodiments is provided so that the disclosure of the present disclosure is complete and to fully inform those with ordinary knowledge in the technical field to which the present disclosure pertains of the scope of the disclosure. In the attached drawings, the components are illustrated with their sizes enlarged compared to the actual size for convenience of explanation, and the proportions of each component may be exaggerated or reduced.

The terms ‘first’, ‘second’ and the like may be used to describe various components, but the components should not be limited by the terms. The above terms may be used only for the purpose of distinguishing one component from another. For example, without departing from the scope of the present disclosure, the ‘first component’ may be named the ‘second component’, and similarly, the ‘second component’ may also be named the ‘first component’. In addition, a singular expression includes a plural expression unless the context clearly indicates otherwise. Terms used in the embodiments of the present disclosure may be interpreted as having meanings commonly known to a person having ordinary skill in the art, unless otherwise defined.

Hereinafter, an initial starting apparatus and method for a solid-state transformer according to an embodiment of the present disclosure will be specifically described with reference to the drawings.

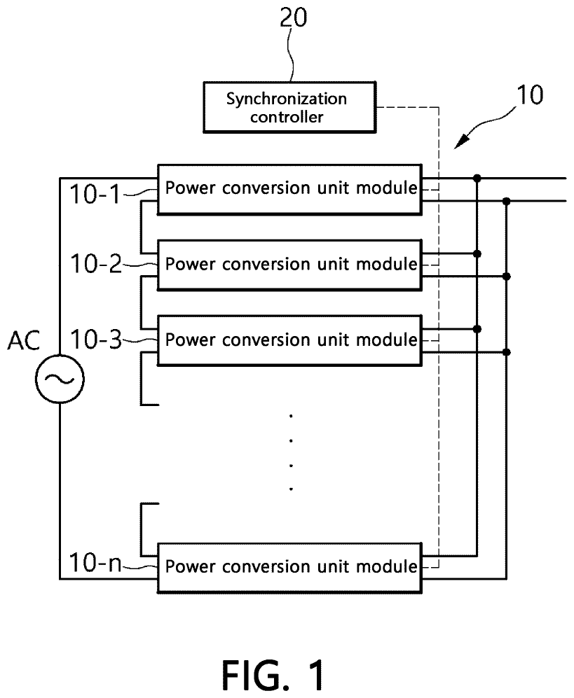

FIG. 1 is a block diagram of an initial starting apparatus of a solid-state transformer according to an embodiment of the present disclosure.

Referring to FIG. 1, the present disclosure may be configured to include a plurality of power conversion unit modules 10-1, 10-2, 10-3, . . . 10-n that are connected in series with respect to a primary voltage and sequentially convert the primary voltage, and a synchronization controller 20 that provides a starting and synchronization signal to the plurality of said power conversion unit modules 10-1, 10-2, 10-3, . . . , 10-n.

Each of the power conversion unit modules 10-1, 10-2, 10-3, . . . 10-n may include various internal configurations depending on the configuration of a solid-state transformer.

For example, each of the unit modules may include an AC/DC rectifier and a DC/DC converter, and may convert a DC voltage of the AC/DC rectifier into a low-voltage DC voltage using the DC/DC converter and supply the same.

If it is necessary to supply AC voltage from the secondary side, it may also be used as a hybrid distribution system structure that adds a DC/AC inverter to the secondary side.

In this way, the power conversion unit modules 10-1, 10-2, 10-3, . . . , 10-n having various structures depending on the need are connected in series with respect to a primary side voltage (AC). Hereinafter, the power conversion unit modules may be abbreviated as ‘unit modules.’

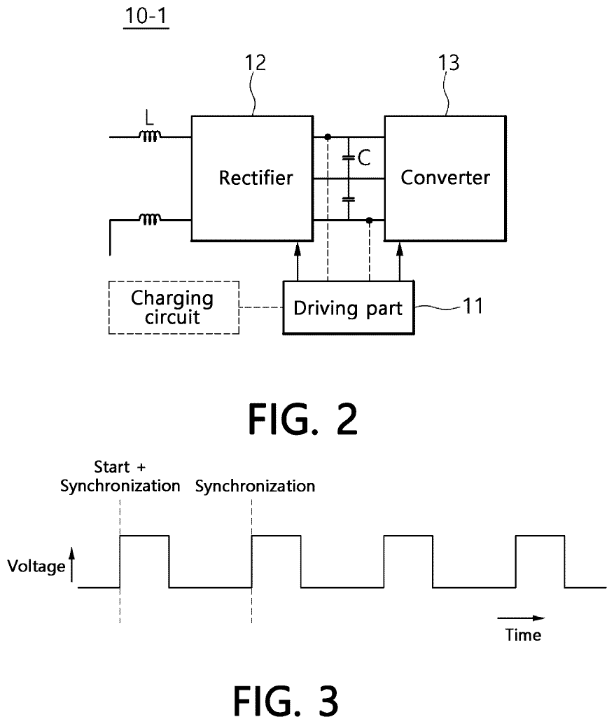

FIG. 2 is a block diagram of a unit module 10-1.

Referring to FIG. 2, the unit module 10-1 applied to the present disclosure is configured to include a driving part 11 that drives a switch constituting a rectifier 12 and a converter 13 according to a synchronization signal provided from an external source (synchronization controller 20).

FIG. 2 shows an example of one unit module 10-1, but other unit modules 10-2, 10-3, . . . , 10-n are also configured in the same manner.

The rectifier 12 and the converter 13 may each use an AFE rectifier and a plurality of full-bridge converters, and in this case, the inputs of the full-bridge converters are connected in series, and the outputs are connected in parallel.

In this way, the rectifier 12 and the converter 13 each include switches, which are a plurality of switching elements, and each of the unit modules 10-1, 10-2, 10-3, . . . 10-n controls the opening and closing of a plurality of switching elements in synchronization.

In addition, the driving part 11 performs a control for starting each of the unit modules 10-1, 10-2, 10-3, . . . 10-n.

Referring to FIG. 2 again, a link capacitor C is included between the rectifier 12 and the converter 13, and the driving part 11 performs a charging control such that the link capacitor C may reach an initial reference value before the actual driving of the solid-state transformer.

In this case, the charging of the link capacitor C may use the rectifier 12 or a separate charging circuit.

That is, the driving part 11 plays a role in charging the link capacitor C for the synchronous control of the rectifier 12 and the converter 13 and the operation of the solid-state transformer. In the past, a configuration was used in which a starting signal for starting was supplied separately from a synchronization signal from the outside.

To this end, a separate communication interface was used to apply a start command, but there was a problem in that it was not easy to operate each unit module 10-1, 10-2, 10-3, . . . 10-n simultaneously due to differences in the data processing method or data processing speed of each unit module 10-1, 10-2, 10-3, . . . 10-n.

In the present disclosure, a separate start command is not used, and the synchronization signal of the synchronization controller 20 may be used as the start command.

FIG. 3 is a waveform diagram of the synchronization signal used in the present disclosure.

Referring to FIG. 3, the synchronization signal may be a square wave, and the synchronization controller 20 outputs the same synchronization signal to the driving part 11 of each unit module 10-1, 10-2, 10-3, . . . 10-n.

The driving part 11 detects a rising edge of the synchronization signal and performs a switch control of the rectifier 12 and converter 13.

In this case, if the rising edge of the square wave is detected, the driving part 11 may recognize it as a start signal.

That is, the driving part 11 determines the rising edge of the square wave of the synchronization signal of the synchronization controller 20 as a start command and a synchronization signal, and performs an operation to charge the link capacitor C. That is, it starts.

Then, the driving part 11 that has detected the second rising edge of the square wave of the input synchronization signal determines it as a synchronization signal, and controls switches of the rectifier 12 and the converter 13.

Therefore, the present disclosure enables the stable operation of a solid-state transformer because a plurality of unit modules 10-1, 10-2, 10-3, . . . 10-n start simultaneously and operate in sync.

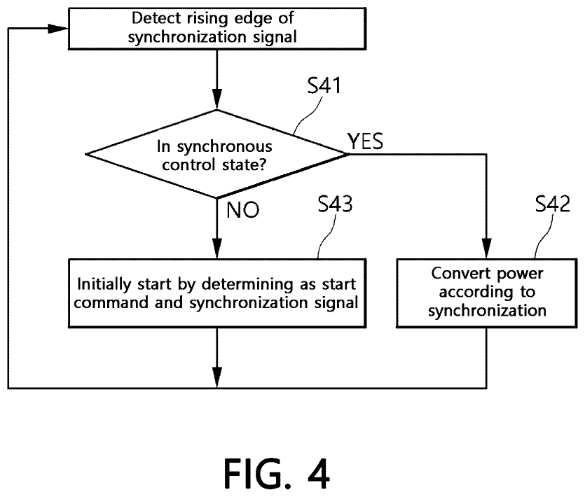

FIG. 4 is a flowchart of a method for initially starting a solid-state transformer according to a preferred embodiment of the present disclosure.

Referring to FIG. 4, the present disclosure includes a step S41 of checking whether it is currently in a synchronization control state if a rising edge of a synchronization signal is detected, a step S42 of performing a synchronization control in synchronization with the rising edge of the synchronization signal if it is in a synchronization control state, and a step S43 of determining as a start command if it is not in a synchronization control state and charging a link capacitor C.

Each of the steps described above is a process that is processed by the driving part 11 configured in each of the unit modules 10-1, 10-2, 10-3, . . . 10-n, and the synchronous control state means a state in which the driving part 11 controls switches of the rectifier 12 and the converter 13.

That is, the present disclosure detects a rising edge of a synchronization signal that is input from the synchronization controller 20 as a start command, and controls each unit module 10-1, 10-2, 10-3, . . . 10-n to be in a start state simultaneously.

In this case, if each unit module 10-1, 10-2, 10-3, . . . 10-n is all operating, the rising edge of the synchronization signal becomes the timing for synchronization. If each unit module 10-1, 10-2, 10-3, . . . 10-n is not operating, it is detected as a start command and a synchronization signal.

In the above example, the synchronization signal is described as a square wave, but its form may be changed as needed, and the start and synchronization control may be performed by detecting a change point of a signal that can be distinguished from the previous state rather than necessarily detecting the rising edge.

Although the embodiments according to the present disclosure have been described above, these are merely exemplary, and those with ordinary skill in the art will understand that various modifications and equivalent embodiments are possible therefrom. Therefore, the true technical protection scope of the present disclosure should be defined by the following claims.

The present disclosure is a technology for controlling the initial operation of an SST using natural laws, and has industrial applicability.

### EXPLANATION OF REFERENCE NUMERALS

10: Solid-state transformer
20: Synchronization controller
10-1, 10-2, 10-3, . . . 10-n: Unit module
11: Driving part
12: Rectifier
13: Converter

1. An initial starting apparatus of a solid-state transformer, comprising:
a plurality of power conversion unit modules connected in series with each other; and
a synchronization controller configured to provide a synchronization signal of a set cycle to the plurality of power conversion unit modules such that the plurality of power conversion unit modules operate according to the synchronization signal, wherein each of the plurality of power conversion unit modules is started by determining a detected synchronization signal as a start signal when not in operation.

2. The initial starting apparatus of claim 1, wherein the power conversion unit module comprises:
a driving part comprising a rectifier and a converter to convert power, and configured to charge a link capacitor between the rectifier and the converter during a startup.

3. The initial starting apparatus of claim 2, wherein the driving part controls a switch of the rectifier or the converter according to the synchronization signal.

4. The initial starting apparatus of claim 2, wherein the driving part controls the rectifier to charge the link capacitor.

5. The initial starting apparatus of claim 2, further comprising:
a charging circuit configured to charge the link capacitor according to a control of the driving part.

6. A method for initially starting a solid-state transformer that comprises a plurality of power conversion unit modules connected in series with each other, and a synchronization controller configured to provide a synchronization signal of a set cycle to the plurality of power conversion unit modules such that the plurality of power conversion unit modules operate according to the synchronization signal, the method comprising:
determining whether a synchronization signal is input from the synchronous controller in each of the plurality of power conversion unit modules;
checking whether the plurality of power conversion unit modules are currently operating if a synchronization signal is input, and determining as a synchronization signal if the plurality of power conversion unit modules are operating; and
determining as a start command if the plurality of power conversion unit modules are not operating to start each of the power conversion unit modules.

7. The method of claim 6, wherein each of the power conversion unit modules comprises a link capacitor connecting the rectifier and the converter, and
wherein a startup of the power conversion unit module is to charge the link capacitor.

8. The method of claim 6, wherein when the synchronization signal is input, if each of the power conversion unit modules is operating, power is converted in synchronization with the synchronization signal.
